(19) United States
(12) Patent Application Publication
(10) Pub. No.: US 2026/0289863 A1
(43) Pub. Date: Sep. 24, 2026

(54) INTERFACE INTERACTION

(71) Applicant: Beijing Zitiao Network Technology Co., Ltd., Beijing (CN)

(72) Inventors: Chunyan ZHANG, Beijing (CN); Shaochuan TANG, Beijing (CN)

(21) Appl. No.: 19/573,800

(22) Filed: Mar. 20, 2026

(30) Foreign Application Priority Data
Mar. 20, 2025 (CN) 202510337991.0

(51) Int. Cl. G06T 11/60; G06Q 30/0207

(52) U.S. Cl. CPC G06T 11/60; G06Q 30/0239; G06T 2200/24

(57) ABSTRACT

The embodiments of the disclosure relate to a method, an apparatus, a device and a storage medium for interface interaction. The method proposed here includes: presenting, to a user, a first viewing interface associated with a service provider, the first viewing interface presenting a content item associated with a first benefit, the first benefit being determined based on a configuration operation of the service provider; posting, based on a trigger on the content item, a media content associated with the service provider; and providing, to the user and in response to the posted media content being determined to satisfy an obtaining condition associated with the first benefit, the first benefit associated with the service provider.

### CROSS-REFERENCE

This application claims priority to Chinese Patent Application No. 202510337991.0, filed on Mar. 20, 2025, and entitled “METHOD, APPARATUS, DEVICE, AND STORAGE MEDIUM FOR INTERFACE INTERACTION”, which is incorporated herein by reference in its entirety.

### FIELD

Example embodiments of the present disclosure generally relate to the field of computers, and in particular, to interface interaction.

### BACKGROUND

With the development of computer technologies, more and more applications may provide various services for users. Such services are closely related to users' lives, for example, travel services, food ordering services, store evaluation services, online shopping services, and the like. Users may participate in promotional activities through applications that provide life services, and how to enable users to participate in promotional activities and use benefits associated with the promotional activities more conveniently and quickly has become an urgent problem to be solved.

### SUMMARY

In a first aspect of the present disclosure, a method for interface interaction is provided. The method includes: presenting, to a user, a first viewing interface associated with a service provider, the first viewing interface presenting a content item associated with a benefit, the first benefit being determined based on a configuration operation of the service provider; posting, based on a trigger on the content item, a media content associated with the service provider; and providing, to the user and in response to the posted media content being determined to satisfy an obtaining condition associated with the first benefit, the first benefit associated with the service provider.

In a second aspect of the present disclosure, an apparatus for interface interaction is provided. The apparatus includes: a first provision module configured to present, to a user, a first viewing interface associated with a service provider, the first viewing interface presenting a content item associated with a first benefit, the first benefit being determined based on a configuration operation of the service provider; a posting module configured to post, based on a trigger on the content item, a media content associated with the service provider; and a second provision module configured to provide, to the user and in response to the published media content being determined to satisfy an obtaining condition associated with the first benefit, the first benefit associated with the service provider.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the device to perform the method of the first aspect.

In a fourth aspect of the present disclosure, a non-transitory computer-readable storage medium is provided. The non-transitory computer-readable storage medium has a computer program stored thereon, the computer program being executable by a processor to implement the method of the first aspect.

It should be understood that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. Throughout the drawings, the same or similar reference signs denote the same or similar elements, where:

FIG. 1 illustrates a schematic diagram of an example environment in which the embodiments according to the present disclosure may be implemented;

FIGS. 2A to 2I illustrate example interfaces according to some embodiments of the present disclosure;

FIG. 3 illustrates a flowchart of an example process of interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be interpreted as limited to the embodiments set forth herein. On the contrary, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the heading of any section/sub-section provided in this article is not restrictive. Various embodiments are described throughout this article, and any type of embodiment may be included under any section/sub-section. In addition, the embodiments described in any section/sub-section may be combined with any other embodiments described in the same section/sub-section and/or different sections/sub-sections in any way.

In the description of the embodiments of the present disclosure, the term “include/comprise”, and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may relate to data of a user, acquisition and/or use of data, etc. These aspects all comply with corresponding laws, regulations and relevant regulations. In the embodiments of the present disclosure, collection, obtaining, processing, processing, forwarding, use, etc. of all data, are performed with the user's knowledge and confirmation. Accordingly, when implementing each embodiment of the present disclosure, the user should be informed of the type, scope of use, usage scenarios, etc. that may be involved in the data or information and obtain their the authorization through appropriate means according to relevant laws and regulations. The specific notification and/or authorization methods may be changed according to the actual situation and application scenarios, and the scope of the present disclosure is not limited in this regard.

If the solutions in this specification and embodiments involve personal information processing, they will all be processed on the premise of a legal basis (for example, obtaining the consent from the data subject or necessary to fulfill a contract, etc.), and will only be processed within the scope of stipulations or agreements. The user's refusing to process any personal information beyond what is necessary for the basic functions will not affect their use of those functions.

As mentioned above, with the development of computer technologies, more and more applications may provide various services for users. Such services are closely related to users' lives, for example, travel services, food ordering services, store evaluation services, online shopping services, and the like. Users may participate in promotional activities through applications that provide life services, and how to enable users to participate in promotional activities and write off benefits associated with the promotional activities more conveniently and quickly has become an urgent problem to be solved.

The embodiments of the present disclosure provide a solution for interface interaction. The solution includes: presenting, to a user, a viewing interface associated with a service provider, the viewing interface presenting a content item associated with a first benefit, the first benefit being determined based on a configuration operation of the service provider; publishing, based on a trigger on the content item, a media content associated with the service provider; and providing, to the user and in response to the published media content being determined to satisfy an obtaining condition associated with the first benefit, the first benefit associated with the service provider.

In this way, the embodiments of the present disclosure support the service provider to configure the first benefit, making the configuration of the first benefit more flexible and efficient. Moreover, the embodiments of the present disclosure may quickly determine whether the media content satisfies the obtaining condition of the first benefit, thereby improving the efficiency of obtaining the benefit.

Various example implementations of this solution will be described in detail below in further with reference to the drawings.

### Example Environment

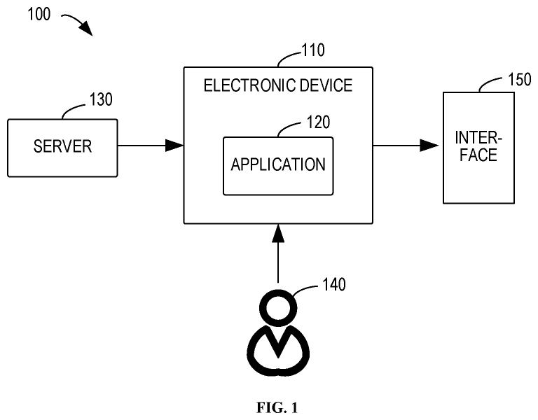

FIG. 1 illustrates a schematic diagram of an example environment 100 in which the embodiments of the present disclosure may be implemented. As shown in FIG. 1, the example environment 100 may include an electronic device 110.

In this example environment 100, an application 120 supporting interface interaction may be run on the electronic device 110. The application 120 may be any appropriate type of application for interface interaction, examples of which may include, but are not limited to, online shopping applications, content sharing applications, or other appropriate applications. The user 140 may interact with the application 120 via the electronic device 110 and/or attached device thereof.

In the environment 100 of FIG. 1, if the application 120 is in an active state, the electronic device 110 may present an interface 150 for supporting interface interaction through the application 120.

In some embodiments, the electronic device 110 communicates with a server 130 to implement the provision of services of the application 120. The electronic device 110 may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a virtual reality/augmented reality VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the above, including accessories and peripherals of these devices or any combination thereof. In some embodiments, the electronic device 110 may also support any type of user-specific interface (such as “wearable” circuits, etc.).

The server 130 may be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and the like. The server 130 may provide background services for the application 120 supporting interface interaction in the electronic device 110.

A communication connection may be established between the server 130 and the electronic device 110. The communication connection may be established via a wired or wireless manner. The communication connection may include, but is not limited to, a Bluetooth connection, a mobile network connection, a Universal Serial Bus (USB) connection, a Wireless Fidelity (Wi-Fi) connection, etc., and the embodiments of the present disclosure are not limited in this regard. In the embodiments of the present disclosure, the server 130 and the electronic device 110 may implement signaling interaction through the communication connection between them.

It should be understood that the structures and functions of the elements in the environment 100 are described for illustrative purposes only, without suggesting any limitation on the scope of the present disclosure.

Some example embodiments of the present disclosure will continue to be described below with reference to the drawings.

### Example Interaction

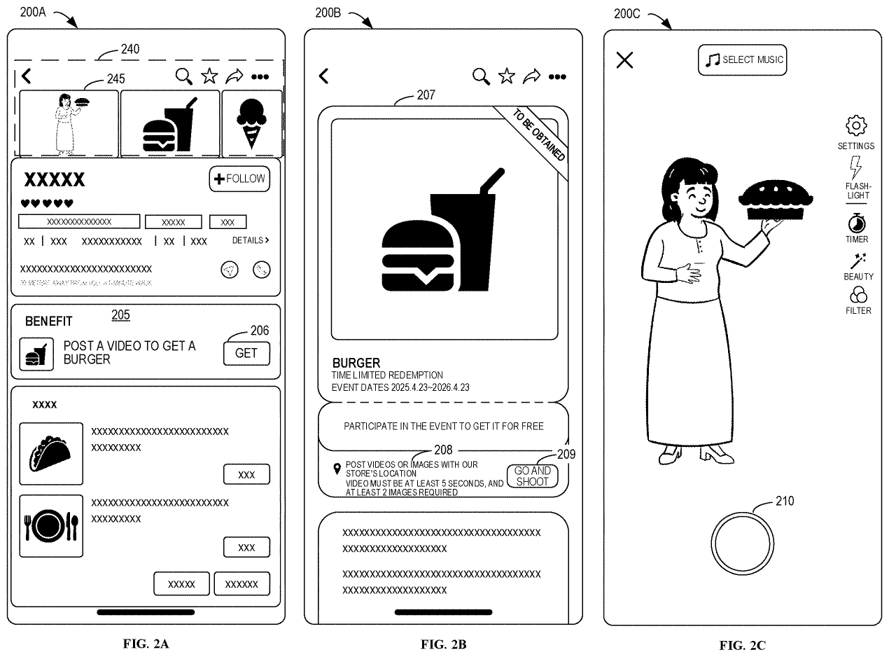

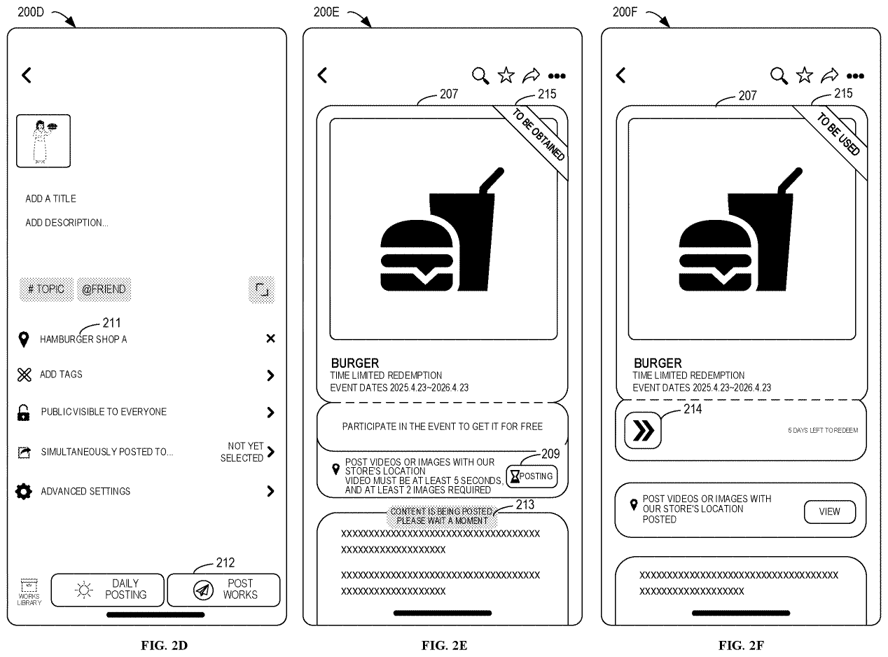

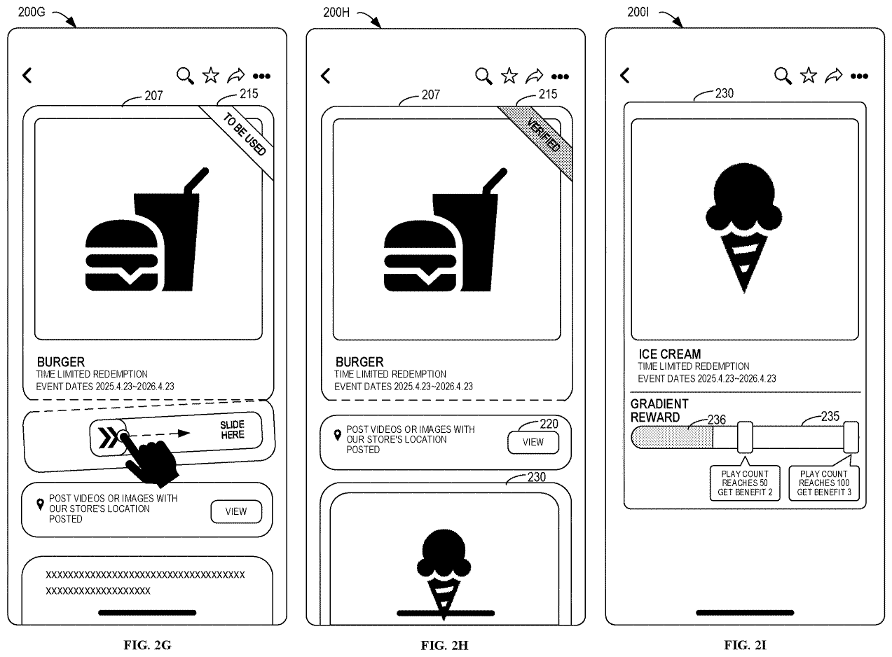

FIGS. 2A to 2I illustrate example interfaces 200A to 200I according to some embodiments of the present disclosure. The interfaces 200A to 200I may be provided by the electronic device 110 shown in FIG. 1, for example.

As mentioned above, with the rapid development of computer technologies, various applications may provide users with various life services. Such life services may include, for example, vertical fields such as travel scheduling, food ordering, store evaluation, and e-commerce transactions. Taking store evaluation as an example, a user may evaluate a corresponding store or participate in various promotional activities in a store evaluation application. Such promotional activities may be, for example, receiving a coupon or receiving a free gift.

Traditionally, when participating in promotional activities, a user usually participates in promotional services through a store evaluation application deployed in a terminal, and complete the activity tasks indicated by the promotional activities (for example, posting store evaluations). After completing the activity task, the user also needs to contact the staff of the corresponding store offline, and the staff will determine offline that the activity task has been completed. It may be seen that the traditional detection process of obtaining condition of the benefit and the obtaining process of the benefit is relatively complicated.

The process of obtaining and using benefits will be described in detail below.

In some embodiments, the electronic device 110 may provide the user with a first viewing interface associated with a service provider. As an example, the service provider may be a merchant that provides products or other appropriate services. The first viewing interface may be, for example, a merchant detail page. Specifically, the electronic device 110 presents, to the user, the first viewing interface associated with the service provider, the first viewing interface presenting a content item associated with a first benefit. The first benefit is determined based on a configuration operation of the service provider. The first benefit is associated with a specified service provided by the service provider. The benefits (including the first benefit, a second benefit, etc.) in the present disclosure may be any appropriate type of payment benefits or exchange benefits, which include, but are not limited to, a reduction of virtual resources that need to be paid, an exchange for a corresponding product, etc. Examples of benefits may be a virtual coupon, a virtual exchange coupon, and the like.

As an example, as shown in FIG. 2A, FIG. 2A illustrates a viewing interface associated with a service provider according to some embodiments of the present disclosure. The electronic device 110 may present the viewing interface 200A associated with the service provider, and the service provider may be, for example, a catering service provider, a transportation service provider, or any other appropriate service provider. In the present disclosure, an example in which the service provider is a catering service provider is taken. The interface 200A includes description information associated with the service provider (for example, the catering service provider), and such description information may include, for example, the name, evaluation information, an address, contact information, and etc. of a store associated with the service provider. The electronic device 110 may also present various benefits (such as a coupon, a product exchange coupon) associated with the service provider in the interface 200A. The various benefits presented in the interface 200A include at least the first benefit, and the first benefit is determined by the configuration operation of the service provider. The first benefit here is associated with the specified service provided by the service provider, and the specified service here may be, for example, exchanging for a corresponding product or enjoying a discount when purchasing a product. In other words, the first benefit may be, for example, a virtual exchange coupon for a product, or a virtual coupon.

The electronic device 110 may present the content item 205 in the interface 200A, and the content item 205 is associated with the first benefit. The content item 205 may be, for example, a benefit item or a benefit card associated with the first benefit. The content item 205 includes partial description information associated with the first benefit, and the partial description information here may include, for example, a text description of an obtaining condition of the first benefit, image content associated with the first benefit (for example, a picture of a product associated with the first benefit), and the like. In this way, the embodiments of the present disclosure present the content item of the first benefit in the viewing interface associated with the service provider, so that the user may view the first benefit more quickly, thereby improving the efficiency of obtaining information.

For the creation of the first benefit, after the configuration operation of the service provider is received by the server 130, the server 130 may determine configuration information associated with the first benefit based on the configuration operation. Such configuration information may include, for example, time information of the first benefit, the name of the first benefit, product information associated with the first benefit, and image content of the first benefit. The time information here indicates a time period during which the first benefit may be obtained or a time period during which the first benefit may be used. Furthermore, the server 130 may create the first benefit based on the above time information, name, product information and image content.

In some embodiments, the electronic device 110 posts, based on a trigger on the content item, the media content associated with the service provider. As an example, as shown in FIG. 2A, after a control 206 in the content item 205 is clicked by the user 140, the electronic device 110 may present a media content obtaining interface to the user 140. Further, the electronic device 110 may obtain, via the media content obtaining interface, media content shot or uploaded by the user, and such media content may be, for example, image content or video content. After obtaining the media content, the electronic device 110 may associate the media content with the service provider, and post the media content associated with the service provider.

In some embodiments, in the case that the content item is triggered, the electronic device 110 may present a second viewing interface associated with the first benefit. The second viewing interface presents first description information of the first benefit and/or second description information of the obtaining condition. As an example, as shown in FIGS. 2A and 2B, the electronic device 110 may receive a click operation of the user on the control 206. After the control 206 is clicked, the electronic device 110 may present the second viewing interface 200B associated with the first benefit. The electronic device 110 may present the first description information of the first benefit in a component 207. The first description information may include, for example, the image content associated with the first benefit, the name of the first benefit, and the time information of the first benefit. The electronic device 110 may also present the second description information 208 of the obtaining condition in the interface 200B. The second description information 208 is configured to describe the obtaining condition of the first benefit, for example, “post a video or picture with the location of our store, with a minimum video length of five seconds and a minimum of two pictures”.

Further, the electronic device 110 may present a shooting interface in response to receiving a predetermined operation in the second viewing interface. Finally, the electronic device 110 may obtain the media content via the shooting interface. As an example, as shown in FIGS. 2B and 2C, after the control 209 in the interface 200B is clicked by the user 140, the electronic device 110 may present the shooting interface 200C. After the shooting control 210 in the interface 200C is selected, the electronic device 110 may obtain, via the media content obtaining interface 200C, the media content shot by the user 140. Such media content may be, for example, image content or video content.

In some embodiments, the electronic device 110 may also obtain the publishing information associated with the media content. Specifically, the electronic device 110 may obtain the posting information of the media content via a posting interface. At least a part of the publishing information is determined based on at least one of the service providers, the first benefit, and the obtaining condition. Further, the electronic device 110 may post the media content based on the posting information.

As an example, as shown in FIG. 2D, after the media content is obtained, the electronic device 110 may present an interface 200D to the user. The interface 200D may be, for example, the posting interface of the media content. The electronic device 110 may provide a plurality of configuration components for the user in the interface 200D, and such configuration components are configured to adjust the posting information of the media content. Such posting information may include, for example, a point of interest associated with the media content, a visible range after the media content is posted, a topic associated with the media content, or a platform for posting the media content. The configuration components include at least an association component 211. The electronic device 110 may obtain, via the association component 211, reference information associated with the service provider, and such reference information may be, for example, the address or name of the store associated with the service provider. The electronic device 110 may determine the point of interest associated with the media content based on the reference information. Further, the electronic device 110 may also present a posting control 212 in the interface 200D, and the posting control 212 is configured to trigger the posting of the media content. After the posting control 212 is clicked by the user 140, the electronic device 110 may post the media content based on the determined posting information.

In some scenarios, when the electronic device 110 obtains the media content, the electronic device 110 may automatically determine at least a part of the posting information of the media content based on the service provider, and presents the posting information in the posting interface. For example, the electronic device 110 may determine the point of interest associated with the media content based on the store associated with the service provider, and present information such as the address and name of the store in the association component 220.

In another scenario, the electronic device 110 may determine, based on the first benefit, the topic in the posting information of the media content (for example, determine the topic in the posting information based on a product type specified by the first benefit). For example, if the product type indicated by the first benefit is food, the electronic device 110 may determine that the topic of the media content should be a food topic, and present the text content associated with the food topic in the posting interface 200D.

Additionally, or alternatively, the electronic device 110 may also determine the posting information of the media content based on the obtaining condition of the first benefit. For example, the obtaining condition of the first benefit is that the posted media content should be set to the state of being visible to all, so in the case that the electronic device 110 obtains the media content, the state of being visible to all may be used as the default state of the visible range of the media content.

In some embodiments, the electronic device 110 may update the second viewing interface to indicate the posting state of the media content in response to receiving the posting operation of the media content. As an example, as shown in FIG. 2E, after the media content is posted, the electronic device 110 may update the second viewing interface (for example, update the style of the control 209 in the second viewing interface). After the media content is posted by the electronic device 110, the electronic device 110 may present a first indication element in the control 209. Such a first indication element is configured to indicate that the media content is being posted, and the first indication element may be, for example, an hourglass style, a clock style, or any other appropriate style. After the control 209 is clicked, the electronic device 110 may present prompt information 213 in the interface 200E, and the prompt information 213 is configured to indicate that the media content is being posted.

In some embodiments, the electronic device 110 provides, to the user and in response to the posted media content being determined to satisfy the obtaining condition associated with the first benefit, the first benefit associated with the service provider. As an example, as shown in FIG. 2D, after the posting control 212 is clicked by the user 140, the electronic device 110 may upload the media content to the server 130. After obtaining the media content, the server 130 may determine, based on the type of the media content, whether the media content satisfies the obtaining condition associated with the first benefit. For example, in the case that the media content is an image content, the server 130 may determine the number of the image content. Further, the server 130 may determine whether the number of the image content satisfies a first threshold, and in response to determining that the number of the image content is greater than or equal to the first threshold, the server 130 may determine that the media content satisfies the obtaining condition of the first benefit. In the case that the media content is video content, the server 130 may determine the duration of the video content. In response to the duration of the video content being greater than a second threshold, the server 130 may determine that the media content satisfies the obtaining condition of the first benefit. The first threshold and the second threshold may be determined by the server 130 based on the configuration operation of the service provider. After the media content is determined to satisfy the obtaining condition associated with the first benefit, the electronic device 110 may provide the first benefit to the user 140.

In some embodiments, in order to enable the user to obtain the first benefit more quickly, the server (for example, the server 130) may automatically determine whether the media content satisfies the obtaining condition of the first benefit. Specifically, the server may determine association information of the media content. The association information includes at least one of a predetermined attribute of the media content and posting information of the media content. Further, the server may determine whether the media content satisfies the obtaining condition associated with the first benefit. The obtaining condition associated with the first benefit is determined based on the configuration operation of the service provider.

As an example, after the media content is obtained by the server 130, the server 130 may determine the association information of the media content. The association information includes the predetermined attribute and the posting information of the media content. The predetermined attribute may include attributes such as the number, duration and theme of the media content. The posting information may include, for example, a point of interest associated with the media content, a title, a topic, the visible range of the media content, and the number of words of the text content posted simultaneously with the media content. After determining the above association information, the server 130 may determine, based on the association information, whether the media content satisfies the obtaining condition of the first benefit. The obtaining condition of the first benefit may be determined by the server 130 based on the configuration operation of the service provider.

In some scenarios, after obtaining the media content, the server 130 may determine whether the predetermined attribute (for example, the duration) of the media content is greater than or equal to the first threshold indicated in the obtaining condition of the first benefit, and determine whether the posting information (for example, the point of interest associated with the media content) of the media content is associated with the service provider. After determining that the duration of the media content is greater than or equal to the first threshold and that the point of interest of the media content is associated with the service provider, the server 130 may determine that the media content satisfies the obtaining condition of the first benefit.

In some other scenarios, after receiving the media content, the server 130 may parse the media content to determine the theme of the media content. After determining that the theme of the media content matches the theme indicated in the obtaining condition of the first benefit (for example, matches the food theme), the server 130 may determine that the media content satisfies the obtaining condition of the first benefit.

Additionally, or alternatively, the server 130 may also determine whether the media content satisfies the obtaining condition of the first benefit based on the visible range of the media content. After receiving the media content, the server 130 may determine the visible range of the media content set by the user 140. In the case that the obtaining condition of the first benefit indicates that the posted media content should be set by the service provider to be visible to all, if the media content posted by the user 140 is set to be visible only to the user himself/herself, the server 130 may determine that the media content does not satisfy the obtaining condition of the first benefit.

Additionally, or alternatively, the server 130 may also determine whether the media content satisfies the obtaining condition of the first benefit based on topic information associated with the media content. The obtaining condition of the first benefit may specify, for example, the type of the topic information associated with the media content, for example, the topic information associated with the media content needs to be of the food type, the sports type or other types configured by the service provider. The topic information here may be set by the user 140 himself/herself through the electronic device 110, or may be determined by the server 130 based on the theme of the media content. The topic information may be, for example, “restaurants in city A that must be eaten”. When the topic information of the media content satisfies the type of the topic information indicated in the obtaining condition of the first benefit, the server 130 may determine that the media content satisfies the obtaining condition of the first benefit.

In this way, the server may determine whether the media content satisfies the obtaining condition of the first benefit based on the association information of the media content, which may effectively improve the verification efficiency of the obtaining condition. Moreover, the embodiments of the present disclosure support the service provider to set the obtaining condition associated with the benefit, which makes the configuration of the obtaining condition more efficient and flexible.

In some embodiments, the electronic device 110 may provide, in the second viewing interface and in response to the user being provided with the first benefit, an interaction control for using the first benefit. The interaction control includes a sliding control, and the sliding control is configured to receive a sliding operation in a predetermined direction to use the first benefit. As an example, as shown in FIG. 2F, after the first benefit is provided, the electronic device 110 may present the interaction control (for example, a sliding control 214) in the second viewing interface 200F. The electronic device 110 may receive the sliding operation of the user 140 via the sliding control 214 to use the first benefit, and such a sliding operation may be, for example, sliding from left to right. In some scenarios, after the first benefit is provided, the electronic device 110 may also present a predetermined area of the content item in a predetermined style. Such a predetermined style is configured to represent that the first benefit has been provided. In this way, the first benefit may be quickly used through the interaction control, thereby improving the efficiency of using the first benefit.

In some scenarios, as shown in FIG. 2G, during the sliding operation, the electronic device 110 may also present a transition animation. The transition animation indicates that the area where the sliding control 214 is located is gradually separated from the component 207 in the direction indicated by the sliding operation.

In some other scenarios, as shown in FIGS. 2E to 2H, the electronic device 110 may also superimpose and present a second indication element 215 on the component. The indication element 215 is configured to indicate the state of the first benefit. Such a state may be, for example, the obtaining state or the use state of the first benefit. The obtaining state indicates whether the first benefit is acquired. The use state indicates whether the first benefit is written off. When the first benefit is not obtained, the electronic device 110 may display “to be obtained” in the indication element. After the first benefit is obtained, the electronic device 110 may display “to be used” in the indication element. After the first benefit is used, the electronic device 110 may display “written off” in the indication element.

In some embodiments, the electronic device 110 may provide, in the second viewing interface, a viewing entrance for the posted media content. Further, a third viewing interface of the media content is presented in response to a selection of the viewing entrance. As an example, as shown in FIG. 2H, after the media content is posted, the electronic device 110 may replace the control 209 for obtaining the media content with the viewing entrance 220 associated with the posted media content. After the viewing entrance is clicked by the user 140, the electronic device 110 may present the third viewing interface. The third viewing interface is configured to view the media content posted by the user 140. In this way, the embodiments of the present disclosure may enable the user to view the posted media content more conveniently, thereby improving the efficiency of obtaining information.

In some embodiments, the electronic device 110 may provide, in the third viewing interface, a first access entrance for accessing the first viewing interface of the service provider. As an example, after the third viewing interface is presented, the electronic device 110 may provide the first access entrance at any appropriate position in the third viewing interface. The first access entrance is configured to jump to the first viewing interface. After the first access entrance is selected, the electronic device 110 may present the first viewing interface of the service provider to the user 140. In this way, the interface jump may be quickly performed, thereby improving the efficiency of viewing information.

In some embodiments, the electronic device 110 may provide, in the second viewing interface, a second content item corresponding to a second benefit. Further, the electronic device 110 may present, in the second content item and in response to the media content being posted, an obtaining progress of the second benefit. The obtaining progress is associated with a second obtaining condition of the second benefit. The second obtaining condition is associated with interaction information of the media content.

As an example, as shown in FIG. 2H, the electronic device 110 may present the second content item 230 in the second viewing interface 200H. The second content item 230 includes description information associated with the second benefit. The description information associated with the second benefit may include, for example, image content and text content associated with the second benefit. The image content may be, for example, a picture of a product indicated by the second benefit, and the text content may include, for example, the name and time information of the second benefit. The time information here indicates a time period during which the second benefit may be received or a time period during which the second benefit may be used.

After the media content is posted, as shown in FIG. 2I, the electronic device 110 may present the obtaining progress of the second benefit in the second content item 230. The obtaining progress of the second benefit may be represented by, for example, a progress bar component 235. A first portion 236 in the progress bar component 235 grows with the growth of the obtaining progress of the second benefit. The progress bar component 235 includes not only the obtaining progress of the second benefit, but also the obtaining condition of the second benefit, the obtaining progress of a third benefit, and the obtaining condition of the third benefit.

In some scenarios, the obtaining of the second benefit may also be determined by the server 130 based on the configuration operation of the service provider for the second benefit. When the interaction information of the media content satisfies a third threshold indicated in the obtaining condition of the second benefit, the electronic device 110 may provide the second benefit to the user. The interaction information here may include, for example, the number of times the media content has been played, the number of likes given to the media content, the number of times the media content has been forwarded, etc.

In some embodiments, in order to enable the user to view the posted media content more conveniently, after the media content is posted, the electronic device 110 may also present the posted media content in the first viewing interface associated with the service provider. As an example, as shown in FIG. 2A, after the media content is posted, the electronic device 110 may present the posted media content 245 in a predetermined area 240 in the first viewing interface 200A. In this way, the embodiments of the present disclosure enable the user to quickly view the posted media content by presenting the posted media content in the first viewing interface, thereby improving the efficiency of obtaining information.

In some scenarios, the predetermined area 240 in the interface 200A includes not only the media content posted by the user 140, but also the media content posted by other users.

In this way, the embodiments of the present disclosure support the service provider to configure the first benefit, making the configuration of the first benefit more flexible and efficient. Moreover, the embodiments of the present disclosure may quickly determine whether the media content satisfies the obtaining condition of the first benefit, thereby improving the efficiency of obtaining the benefit.

### Example Process

FIG. 3 illustrates a flowchart of an example process 300 of interface interaction according to some embodiments of the present disclosure. The process 300 may be implemented at the electronic device 110. The process 300 is described below with reference to FIG. 1.

As shown in FIG. 3, at a block 310, the electronic device 110 presents a first viewing interface associated with a service provider to a user, the first viewing interface presenting a content item associated with a first benefit, the first benefit being determined based on a configuration operation of the service provider.

At a block 320, the electronic device 110 posts, based on a trigger on the content item, a media content associated with the service provider.

At a block 330, the electronic device 110 provides, to the user and in response to the posted media content being determined to satisfy an obtaining condition associated with the first benefit, the first benefit associated with the service provider.

In some embodiments, the media content is determined whether to satisfy the obtaining condition associated with the first benefit through: determining, by a server, association information of the media content; determining whether the media content satisfies the obtaining condition associated with the first benefit.

In this way, the embodiments of the present disclosure determine more efficiently whether the media content satisfies the obtaining condition associated with the first benefit.

In some embodiments, the association information includes at least one of the following: a predetermined attribute of the media content; posting information of the media content.

In this way, the embodiments of the present disclosure may determine whether the media content satisfies the obtaining condition of the first benefit through various indicators, thereby determining the condition more accurately.

In some embodiments, the obtaining condition associated with the first benefit is determined based on the configuration operation of the service provider.

In this way, the embodiments of the present disclosure support the service provider to configure the obtaining condition, thereby making the configuration of the obtaining condition more flexible and efficient.

In some embodiments, the process 300 further includes: presenting, in response to the trigger on the content item, a second viewing interface associated with the first benefit, the second viewing interface presenting first description information of the first benefit and/or second description information of the obtaining condition; presenting a shooting interface in response to receiving a predetermined operation in the second viewing interface; and obtaining the media content via the shooting interface.

In this way, the embodiments of the present disclosure may enable the user to shoot the media content more conveniently.

In some embodiments, the process 300 further includes: updating, in response to receiving a posting operation of the media content, the second viewing interface to indicate a posting state of the media content.

In this way, the embodiments of the present disclosure may timely provide the posting state of the media content to the user, thereby improving the interaction experience of the user.

In some embodiments, the process 300 further includes: providing an interaction control for using the first benefit, in the second viewing interface, in response to the user being provided with the first benefit.

In this way, the embodiments of the present disclosure may use the first benefit through the interaction control, thereby improving the efficiency of using the benefit.

In some embodiments, the interaction control includes a sliding control, and the sliding control is configured to receive a sliding operation in a predetermined direction to use the first benefit.

In this way, the embodiments of the present disclosure may improve the efficiency of using the benefit.

In some embodiments, the process 300 further includes: providing, in the second viewing interface, a viewing entrance for the posted media content; and presenting, in response to a selection of the viewing entrance, a third viewing interface of the media content.

In this way, the embodiments of the present disclosure may enable the user to quickly view the posted media content, thereby improving the efficiency of obtaining information.

In some embodiments, the obtaining condition is a first obtaining condition, and the process 300 further includes: providing, in the second viewing interface, a second content item corresponding to a second benefit; and presenting, in response to the media content being posted, an obtaining progress of the second benefit in the second content item, the obtaining progress being associated with a second obtaining condition of the second benefit.

In this way, the embodiments of the present disclosure may provide the obtaining progress of the second benefit to the user, so that the user may view the obtaining progress at any time, thereby improving the interaction experience of the user.

In some embodiments, the second obtaining condition is associated with interactive information of the media content.

In this way, the embodiments of the present disclosure may determine the second obtaining condition of the second benefit based on the interactive information of the media content, thereby enriching the obtaining manners of the second benefit.

In some embodiments, posting the media content includes: obtaining, via a posting interface, posting information of the media content, wherein at least a portion of the posting information is determined based on at least one of the following: the service provider, the first benefit, and the obtaining condition; and posting the media content based on the posting information.

In this way, the embodiments of the present disclosure may post the media content based on the posting information, thereby enriching the posting means of the media content and satisfying the interaction needs of the user.

In some embodiments, the first benefit is associated with a specified service provided by the service provider.

In this way, the embodiments of the present disclosure may more clearly represent the service indicated by the first benefit, thereby improving the interaction experience of the user.

In some embodiments, the process 300 further includes: providing, in the third viewing interface of the media content, a first access entrance for accessing the first viewing interface of the service provider; or presenting, in the first viewing interface of the service provider, the posted media content.

In this way, the embodiments of the present disclosure provide the user with a plurality of manners for viewing the posted media content, so that the viewing manners of the media content may be enriched and the interaction needs of the user may be satisfied.

### Example Apparatus and Device

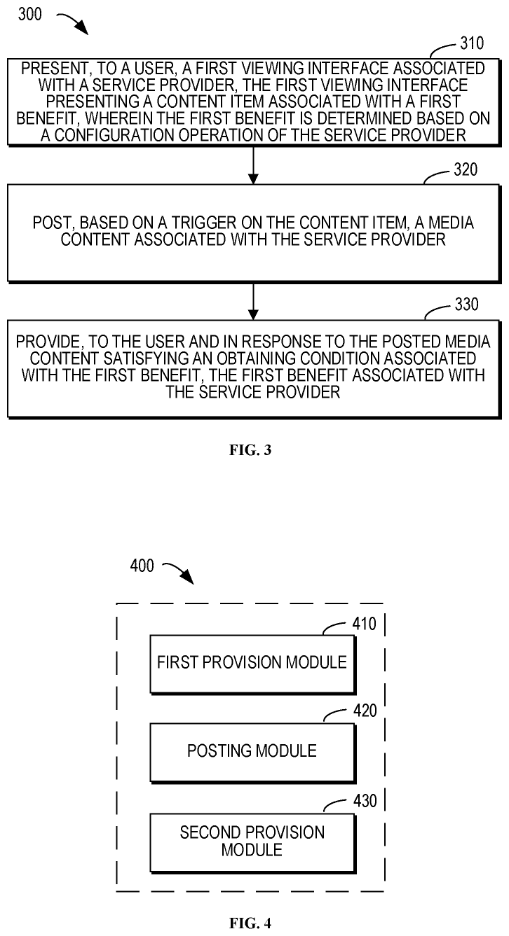

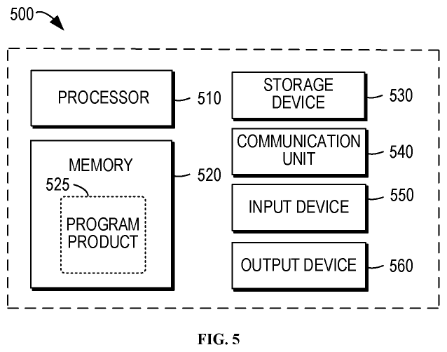

The embodiments of the present disclosure further provide corresponding apparatuses for implementing the above methods or processes. FIG. 4 illustrates a schematic structural block diagram of an example apparatus 400 for interface interaction according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes: a first provision module 410 configured to present, to a user, a first viewing interface associated with a service provider, the first viewing interface presenting a content item associated with a first benefit, the first benefit being determined based on a configuration operation of the service provider; a posting module 420 configured to post, based on a trigger on the content item, media content associated with the service provider; and a second provision module 430 configured to provide, to the user and in response to the posted media content being determined to satisfy an obtaining condition associated with the first benefit, the first benefit associated with the service provider.

In some embodiments, the media content is determined whether to satisfy the obtaining condition associated with the first benefit based on the following process: determining, by a server, association information of the media content; determining whether the media content satisfies the obtaining condition associated with the first benefit.

In some embodiments, the association information includes at least one of the following: a predetermined attribute of the media content; posting information of the media content.

In some embodiments, the obtaining condition associated with the first benefit is determined based on the configuration operation of the service provider.

In some embodiments, the apparatus 400 further includes a first presentation module configured to present, in response to the trigger on the content item, a second viewing interface associated with the first benefit, the second viewing interface presenting first description information of the first benefit and/or second description information of the obtaining condition; present a shooting interface in response to receiving a predetermined operation in the second viewing interface; and obtain the media content via the shooting interface.

In some embodiments, the apparatus 400 further includes an updating module configured to update, in response to receiving a posting operation of the media content, the second viewing interface to indicate a posting state of the media content.

In some embodiments, the apparatus 400 further includes a third provision module configured to provide an interaction control for using the first benefit, in the second viewing interface, in response to the user being provided with the first benefit.

In some embodiments, the interaction control includes a sliding control, and the sliding control is configured to receive a sliding operation in a predetermined direction to use the first benefit.

In some embodiments, the apparatus 400 further includes an entrance provision module configured to provide, in the second viewing interface, a viewing entrance for the posted media content; and present, in response to a selection of the viewing entrance, a third viewing interface of the media content.

In some embodiments, the obtaining condition is a first obtaining condition, and the apparatus 400 further includes a progress presentation module configured to provide, in the second viewing interface, a second content item corresponding to a second benefit; and present, in response to the media content being posted, an obtaining progress of the second benefit in the second content item, the obtaining progress being associated with a second obtaining condition of the second benefit.

In some embodiments, the second obtaining condition is associated with interactive information of the media content.

In some embodiments, the posting module 420 is further configured to: obtain, via a posting interface, posting information of the media content, wherein at least a portion of the posting information is determined based on at least one of the following: the service provider, the first benefit, and the obtaining condition; and post the media content based on the posting information.

In some embodiments, the first benefit is associated with a specified service provided by the service provider.

In some embodiments, the apparatus 400 further includes a content presentation module configured to provide, in the third viewing interface of the media content, a first access entrance for accessing the first viewing interface of the service provider; or present, in the first viewing interface of the service provider, the posted media content.

The modules included in the apparatus 400 may be implemented in various manners, including software, hardware, firmware, or any combination thereof. In some embodiments, one or more modules may be implemented using software and/or firmware, for example, machine executable instructions stored on a storage medium. In addition to machine executable instructions or as an alternative, some or all units in the apparatus 400 may be implemented at least partially by one or more hardware logic components. As an example, rather than a limitation, illustrative types of hardware logic components that may be used include field programmable gate array (FPGA), application specific integrated circuit (ASIC), application specific standard (ASSP), system on chip (SOC), complex programmable logic device (CPLD), etc.

FIG. 5 illustrates a block diagram of an electronic device 500 in which one or more embodiments of the present disclosure may be implemented. It should be understood that the electronic device 500 shown in FIG. 5 is only illustrative, and should not constitute any limitation on the functions and scope of the embodiments described herein. The electronic device 500 shown in FIG. 5 may be used to implement the electronic device 110 as discussed above.

As shown in FIG. 5, the electronic device 500 is in the form of a general electronic device. The components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor, and may execute various processes based on the programs stored in the memory 520. In a multi-processor system, multiple processors execute computer executable instructions in parallel to improve the parallel processing capability of the electronic device 500.

The electronic device 500 usually includes multiple computer storage media. Such media may be any available media that may be accessed by the electronic device 500, including, but not limited to, volatile and non-volatile media, removable and non-removable media. The memory 520 may be a volatile memory (for example, a register, cache, random access memory (RAM)), a non-volatile memory (for example, a read-only memory (ROM), electrically erasable programmable read-only memory (EEPROM), flash memory), or a combination thereof. The storage device 530 may be a removable or non-removable medium, and may include a machine readable medium such as a flash drive, a disk, or any other medium, which may be used to store information and/or data and may be accessed within the electronic device 500.

The electronic device 500 may further include other removable/non-removable, volatile/non-volatile storage media. Although not shown in FIG. 5, a disk drive for reading from or writing to a removable, non-volatile disk (such as a “floppy disk”), and an optical disk drive for reading from or writing to a removable, non-volatile optical disk may be provided. In these cases, each drive may be connected to a bus (not shown) by one or more data medium interfaces. The memory 520 may include a computer program product 525, which has one or more program modules that are configured to perform various methods or actions of the various embodiments of the present disclosure.

The communication unit 540 implements communication with other electronic devices through communication media. In addition, the functions of the components of the electronic device 500 may be implemented by a single computing cluster or a plurality of computing machines, which may communicate through a communication connection. Therefore, the electronic device 500 may use a logical connection with one or more other servers, network personal computers (PCs) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, the external devices such as a storage device, a display device, etc., communicate with one or more devices that enable the user to interact with the electronic device 500, or communicate with any device (such as a network card, a modem, etc.) that enables the electronic device 500 to communicate with one or more other electronic devices. Such communication may be performed via input/output (I/O) interfaces (not shown).

According to an illustrative implementation of the present disclosure, a computer-readable storage medium is provided, which has computer executable instructions stored thereon, where the computer executable instructions are executed by a processor to implement the method described above. According to an illustrative implementation of the present disclosure, there is further provided a computer program product, the computer program product is tangibly stored on a non-transitory computer-readable medium and includes computer executable instructions, and the computer executable instructions are executed by a processor to implement the method described above.

Various aspects of the present disclosure are described herein with reference to the flowcharts and/or block diagrams of the methods, apparatuses, devices and computer program products implemented according to the present disclosure. It should be understood that each block of the flowcharts and/or block diagrams, and combinations of blocks in the flowcharts and/or block diagrams, may be implemented by computer readable program instructions.

These computer readable program instructions may be provided to the processor of a general-purpose computer, a special-purpose computer, or other programmable data processing apparatus, so as to produce a machine, such that when these instructions are executed by the processor of the computer or other programmable data processing apparatus, an apparatus for implementing the functions/actions specified in one or more blocks of the flowcharts and/or block diagrams is produced. These computer readable program instructions may also be stored in a computer-readable storage medium, these instructions enable the computer, the programmable data processing apparatus, and/or other devices to work in a specific manner, and thus, the computer-readable medium storing the instructions includes a manufactured product, which includes instructions for implementing various aspects of the functions/actions specified in one or more blocks of the flowcharts and/or block diagrams.

The computer readable program instructions may be loaded onto a computer, other programmable data processing apparatus, or other devices, so that a series of operation steps are performed on the computer, other programmable data processing apparatus, or other devices to produce a computer-implemented process, thereby enabling the instructions executed on the computer, other programmable data processing apparatus, or other devices to implement the functions/actions specified in one or more blocks of the flowcharts and/or block diagrams.

The flowcharts and block diagrams in the drawings show the possibly implemented architectures, functions and operations of the system, method and computer program product according to multiple implementations of the present disclosure. In this regard, each block in the flowchart or block diagram may represent a module, program segment, or part of an instruction, and the module, program segment, or part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

The implementations of the present disclosure have been described above, and the above description is illustrative, non-exhaustive, and not limited to the disclosed implementations. Without departing from the scope and spirit of the illustrated implementations, many modifications and changes will be apparent to those of ordinary skill in the art. The choice of terms used herein is intended to best explain the principles of each implementation, practical applications, or improvements to the technology in the market, or to enable other those of ordinary skill in the art to understand each implementation disclosed herein.

1. A method for interface interaction, comprising:
presenting, to a user, a first viewing interface associated with a service provider, the first viewing interface presenting a content item associated with a first benefit, wherein the first benefit is determined based on a configuration operation of the service provider;
posting, based on a trigger on the content item, a media content associated with the service provider; and
providing, to the user and in response to the posted media content satisfying an obtaining condition associated with the first benefit, the first benefit associated with the service provider.

2. The method of claim 1, wherein the media content is determined whether to satisfy the obtaining condition associated with the first benefit through:
determining, by a server, association information of the media content;
determining whether the media content satisfies the obtaining condition associated with the first benefit.

3. The method of claim 2, wherein the association information comprises at least one of:
a predetermined attribute of the media content; or
posting information of the media content.

4. The method of claim 1, wherein the obtaining condition associated with the first benefit is determined based on the configuration operation of the service provider.

5. The method of claim 1, further comprising:
presenting, in response to the trigger on the content item, a second viewing interface associated with the first benefit, the second viewing interface presenting first description information of the first benefit and/or second description information of the obtaining condition;
presenting a shooting interface, in response to receiving a predetermined operation in the second viewing interface; and
obtaining the media content via the shooting interface.

6. The method of claim 5, further comprising:
updating, in response to receiving a posting operation of the media content, the second viewing interface to indicate a posting state of the media content.

7. The method of claim 5, further comprising:
providing an interaction control for using the first benefit in the second viewing interface, in response to the user being provided with the first benefit.

8. The method of claim 7, wherein the interaction control comprises a sliding control, and the sliding control is configured to receive a sliding operation in a predetermined direction to use the first benefit.

9. The method of claim 5, further comprising:
providing, in the second viewing interface, a viewing entrance for the published media content; and
presenting, in response to a selection of the viewing entrance, a third viewing interface of the media content.

10. The method of claim 5, wherein the obtaining condition is a first obtaining condition, and the method further comprises:
providing, in the second viewing interface, a second content item corresponding to a second benefit; and
presenting, in response to the media content being posted, an obtaining progress of the second benefit in the second content item, the obtaining progress being associated with a second obtaining condition of the second benefit.

11. The method of claim 10, wherein the second obtaining condition is associated with interactive information of the media content.

12. The method of claim 1, wherein posting the media content comprises:
obtaining, via a posting interface, posting information of the media content, wherein at least a portion of the posting information is determined based on at least one of the following: the service provider, the first benefit, and the obtaining condition; and
posting, based on the publishing information, the media content.

13. The method of claim 1, wherein the first benefit is associated with a specified service provided by the service provider.

14. The method of claim 1, further comprising:
providing, in a third viewing interface of the media content, a first access entrance for accessing the first viewing interface of the service provider; or
presenting, in the first viewing interface of the service provider, the published media content.

15. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
presenting, to a user, a first viewing interface associated with a service provider, the first viewing interface presenting a content item associated with a first benefit, wherein the first benefit is determined based on a configuration operation of the service provider;
posting, based on a trigger on the content item, a media content associated with the service provider; and
providing, to the user and in response to the posted media content satisfying an obtaining condition associated with the first benefit, the first benefit associated with the service provider.

16. The electronic device of claim 15, wherein the media content is determined whether to satisfy the obtaining condition associated with the first benefit through:
determining, by a server, association information of the media content;
determining whether the media content satisfies the obtaining condition associated with the first benefit.

17. The electronic device of claim 16, wherein the association information comprises at least one of:
a predetermined attribute of the media content; or
posting information of the media content.

18. The electronic device of claim 15, wherein the obtaining condition associated with the first benefit is determined based on the configuration operation of the service provider.

19. The electronic device of claim 15, wherein the acts further comprise:
presenting, in response to the trigger on the content item, a second viewing interface associated with the first benefit, the second viewing interface presenting first description information of the first benefit and/or second description information of the obtaining condition;
presenting a shooting interface, in response to receiving a predetermined operation in the second viewing interface; and
obtaining the media content via the shooting interface.

20. A non-transitory computer-readable storage medium having a computer program stored thereon, the computer program being executable by a processor to implement acts comprising:
presenting, to a user, a first viewing interface associated with a service provider, the first viewing interface presenting a content item associated with a first benefit, wherein the first benefit is determined based on a configuration operation of the service provider;
posting, based on a trigger on the content item, a media content associated with the service provider; and
providing, to the user and in response to the posted media content satisfying an obtaining condition associated with the first benefit, the first benefit associated with the service provider.
